(19) United States
(12) Patent Application Publication
(10) Pub. No.: US 2025/0291168 A1
(43) Pub. Date: Sep. 18, 2025

(54) Apparatus and Method for Microscopic Optical Manipulation of a Sample, Microscope and Method for Microscopy

(71) Applicant: Carl Zeiss Microscopy GmbH, Jena (DE)

(72) Inventors: Richard Hollinger, Jena (DE); Joerg Siebenmorgen, Jena (DE); Ralf Netz, Jena (DE)

(21) Appl. No.: 19/078,480

(22) Filed: Mar. 13, 2025

(30) Foreign Application Priority Data
Mar. 13, 2024 (DE) 10 2024 107 201.6

(51) Int. Cl. G02B 21/06; G02B 21/16

(52) U.S. Cl. CPC G02B 21/06; G02B 21/16

(57) ABSTRACT

An apparatus for microscopic optical manipulation of a sample, having a light source for transmitting manipulation light, an illumination beam path with a microscope objective for guiding the manipulation light onto and/or into a sample located in a sample plane, wherein a spatial light modulator is arranged in the illumination beam path, in or near a pupil plane, and a controller at least configured to control the spatial light modulator for implementing illumination patterns in the sample plane. A controllable wobble device is present for moving an illumination pattern within the sample plane and the control device is configured to control the wobble device so that amounts of light in each case radiated onto individual points in an irradiated region in the sample plane are homogenized over a time interval.

The current application claims the benefit of German Patent Application No. 10 2024 107 201.6, filed on 13 Mar. 2024, which is hereby incorporated by reference.

In a first aspect, the invention relates to an apparatus for microscopic optical manipulation of a sample, according to the preamble of Claim 1. In a second aspect, the invention relates to a method for microscopic optical manipulation of a sample, according to the preamble of Claim 21. In further aspects, the invention relates to a microscope and a microscopy method.

A generic apparatus for microscopic optical manipulation of a sample comprises at least the following constituent parts: a light source for transmitting manipulation light, an illumination beam path with a microscope objective for guiding the manipulation light onto and/or into a sample to be manipulated located in a sample plane, wherein a spatial light modulator is arranged in the illumination beam path, in or near a pupil plane of the illumination beam path. A controller is present for controlling at least the spatial light modulator and configured to control the spatial light modulator for the purpose of implementing illumination patterns in the sample plane.

In a generic method for microscopic optical manipulation of a sample, at least the following method steps are performed: manipulation light is guided onto and/or into a sample to be examined located in a sample plane, via an illumination beam path with a microscope objective, the manipulation light is guided via a spatial light modulator that is arranged in or near a pupil plane of the illumination beam path, and the manipulation light is modulated by the spatial light modulator for the purpose of realizing an illumination pattern in the sample plane.

Generic apparatuses and generic methods are known, [6].

The field is generated with the aid of a scanned point or a scanned small field in the context of ASTER technology (https://www.abbelight.com/aster-technologie-abbelight/), which was developed by Abbelight and essentially serves to implement what are known as flattop illuminations, i.e. those illuminations in which rectangular regions on a sample are illuminated as homogeneously as possible. In a manner similar to what is implemented using ASTER technology, a MEMS (MEMS=microelectromechanical system) scanner can be used to implement a flattop illumination by fast scanning of a Gaussian beam, [7].

It is known that a spatial light modulator, for example a phase-modulating spatial light modulator, arranged in a pupil plane or in the vicinity of a pupil plane of an illumination beam path, can be used to create a spatially structured illumination pattern in an intermediate image plane disposed downstream in the illumination beam path. The pupil plane and the intermediate image plane are in this case interlinked via a lens that performs a Fourier transform. This lens, also referred to as a Fourier lens, is arranged between the pupil plane and the intermediate image plane and, with respect to each of these planes, is in each case at a distance corresponding to the focal length f of the lens. By way of the phase patterns used to control the phase-modulating spatial light modulator in the pupil plane, substantially any desired amplitude patterns can be created in the intermediate image plane. A phase pattern suitable for generating a defined amplitude pattern can be ascertained for example with the aid of the iterative Gerchberg-Saxton algorithm, which is also known by the designation IFTA (Iterative Fourier Transform Algorithm).

Available pixelated spatial light modulators are very flexible in respect of the generatable phase and amplitude patterns. However, since lasers are usually used as light sources, bothersome spot-like structures, which are also referred to as speckle structures, arise in the generated patterns on account of the coherence of the laser light. Additional apparatus-related or method-related measures must be taken in order to remove these bothersome structures. For example, moving diffusing plates are used, or a plurality of phase patterns are used in the pupil plane for the purpose of generating one and the same amplitude pattern in an intermediate image plane. Laterally displacing phase patterns in the pupil plane, which are used to generate an amplitude pattern, on the spatial light modulator in the pupil plane has also been proposed.

The problem addressed by the invention may be considered that of specifying an apparatus and a method for microscopic optical manipulation of a sample, in which bothersome light patterns in the illumination may be removed with little outlay and effectively.

This problem is solved by the apparatus having the features of Claim 1 and by the method having the features of Claim 21. A microscope having the features of Claim 16 and a microscopy method having the features of Claim 22 are also Claimed.

According to the invention, the apparatus of the type set forth at the outset is developed in that the illumination beam path comprises a controllable wobble device for moving an illumination pattern back and forth within the sample plane and in that the control device is configured to control the wobble device in such a way that amounts of light in each case radiated onto individual points in an irradiated region in the sample plane are homogenized over a time interval.

According to the invention, the method of the type set forth at the outset is developed in that at least parts of the illumination pattern are moved back and forth in the image plane in at least one dimension by a wobble device, for the purpose of homogenizing amounts of light in each case radiated onto individual points of an irradiated region in the sample plane over a time interval.

The microscope according to the invention comprises at least the following constituent parts: an apparatus according to the invention for microscopic optical manipulation of the sample, a detector for detecting detection light emitted by the sample owing to illumination with excitation light, and a detection beam path, comprising the microscope objective or a further microscope objective, for guiding the detection light onto the detector.

At least the following method steps are performed in the microscopy method according to the invention: a sample is manipulated using the method according to the invention for microscopic optical manipulation, the sample is illuminated by the manipulation light as excitation light and/or by further excitation light, and detection light emitted by the sample owing to illumination with excitation light is guided onto a detector via the microscope objective or a further microscope objective and is detected by said detector.

Advantageous exemplary embodiments of the apparatus according to the invention for microscopic optical manipulation of a sample and of the microscope according to the invention and preferred variants of the method according to the invention for microscopic optical manipulation of a sample and of the microscopy method according to the invention are explained below, in particular with reference to the dependent claims and the figures.

The method according to the invention for microscopic optical manipulation of a sample may be carried out using the device according to the invention for microscopic optical manipulation of a sample. The apparatus according to the invention for microscopic optical manipulation of a sample may be configured to perform the method according to the invention for microscopic optical manipulation of a sample. The microscopy method according to the invention may be performed using the microscope according to the invention. The microscope according to the invention may be configured to perform the microscopy method according to the invention. The apparatus according to the invention may also be referred to as an optical manipulator, and the method according to the invention for microscopic optical manipulation may also be referred to as a manipulation method.

The term optical manipulation should be understood to mean any permanent or only temporary physical change to a sample that can be brought about by irradiating the sample with manipulation light.

This optical manipulation is microscopic to the extent that it is possible to perform spatially structured manipulations with structure dimensions that are of the order of the optical resolving power of the utilized microscope objective or even below this for some microscopy methods.

An example of an optical manipulation that may typically be performed using the apparatus according to the invention and the method according to the invention is that of exciting dye molecules, used to prepare a sample, into fluorescing states. Thereupon, fluorescence emitted by the sample may be observed using the microscope according to the invention. Further examples of manipulations include bleaching of fluorescent dyes, quenching of fluorescent dyes and releasing of particles in the sample (uncaging).

In principle, there are no restrictions as regards the samples to be manipulated or examined. There are particularly advantageous use options for the apparatus according to the invention, the microscope according to the invention and the methods according to the invention for biological samples.

The actual starting point for the invention lay in disadvantageous structures in light patterns, the cause of which can be found in the use of lasers, thus coherent light sources. In this respect, lasers are preferably used as light sources. In view of the advantageous properties of the achievable illumination patterns, however, exemplary embodiments in which non-coherent light sources are used are also possible.

The manipulation light and/or excitation light is electromagnetic radiation in the visible range and adjoining ranges.

The term “illumination beam path” denotes all optical beam-guiding and beam-modifying components, for example a microscope objective, lenses, mirrors, prisms, gratings, filters, stops, beam splitters, modulators, e.g. spatial light modulators (SLM), by means of which and via which manipulation light and/or excitation light is guided up to the sample to be manipulated and/or examined. Beam-modifying components may also comprise dispersive and in particular diffractive elements. Commercially available microscope objectives can be used, in principle.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

Spatial light modulators (SLM=Spatial Light Modulator) are equipment which can vary a phase and/or an amplitude of incident light in a location-dependent manner in the beam cross section. This can be done individually for each point in the beam cross section. Spatial light modulators can have for example 1920×1080 elements on a chip with a chip diagonal of one to two centimetres. In the case of ferroelectric spatial light modulators, comparatively high repetition rates of several kHz are possible, but they are inefficient with a luminous efficiency of only approximately 5%. In the case of nematic spatial light modulators, although only repetition rates of 60 Hz to 180 Hz are possible, luminous efficiencies of up to 80% can be achieved. In this case, the term luminous efficiency denotes the ratio between the light incident on the respective spatial light modulator and the light shaped by this light modulator.

The spatial light modulator can be, in principle, the sole spatial light modulator in the illumination beam path. However, it is also possible for the spatial light modulator to be a first spatial light modulator and for a second spatial light modulator to be arranged in the illumination beam path and to be situated in an intermediate image plane or in the vicinity of an intermediate image plane. In a particularly preferred configuration, the first spatial light modulator can be formed by a first sub-region of a spatial light modulator, and the second spatial light modulator can be formed by a second sub-region of the same spatial light modulator. In principle, it is possible for one, several or all of the components of first spatial light modulator, second spatial light modulator, spatial light modulator to be formed by an amplitude-modulating spatial light modulator. It is advantageous, however, if one, several or all of the components of first spatial light modulator, second spatial light modulator, spatial light modulator is or are formed by a phase-modulating spatial light modulator. Phase-modulating spatial light modulators are preferred in general owing to the smaller light losses. Then, one, several or all of the components of first spatial light modulator, second spatial light modulator, spatial light modulator can be formed by a reflective spatial light modulator. However, it is also possible for one, several or all of the components of first spatial light modulator, second spatial light modulator, spatial light modulator to be formed by a transmissive spatial light modulator. By way of example, one, several or all of the components of first spatial light modulator, second spatial light modulator, spatial light modulator can be formed by one or more of the following components: DMD (Digital Mirror Device), nematic SLM, LCOS display (LCOS=Liquid Crystal on Silicon), variable phase plate, controllable deformable mirror (DM).

The term controller denotes all hardware and software components that interact with the components of the apparatus according to the invention and of the microscope according to the invention, in each case for the intended function thereof. In particular, the controller may comprise a computing device, for example a PC, and a camera controller. The computer resources of the controller may be distributed among a plurality of computers and optionally a computer network, in particular also via the Internet. The controller may have in particular customary operating equipment and peripherals, such as mouse, keyboard, screen, storage media, joystick, Internet connection. The controller may in particular read the data, for example image data, from the detector and may also be configured and serve to control the light source. According to the invention, the controller is at least configured to control the spatial light modulator. If further spatial light modulators are present, the control unit can advantageously also be configured for controlling these further light modulators.

Control patterns for the spatial light modulator in the pupil plane which allows a desired illumination pattern to be attained in an intermediate image plane and sample plane can be obtained using the Gerchberg-Saxton algorithm [9], [10], [11]. In principle, any desired patterns, including three-dimensional patterns, can be created, although the computational complexity is considerable.

Moreover, the control pattern may be calculated using what are known as superposition algorithms, in which, for the purpose of displaying a plurality of points in two or three dimensions, a hologram in each case consisting of a lateral translation term (blazed grating) and an axial defocus term (Fresnel lens) is created for each of the points. These algorithms have comparatively low computational complexity [10].

Finally, the control pattern may be calculated using what is known as the phase grating method. In this case, a desired intensity distribution is created by a procedure in which the optical plane of the spatial light modulator in the pupil plane or of the spatial light modulator in the intermediate image plane is areally illuminated and then a phase grating diffracts only the respectively desired intensity distribution over the optical axis. This may be achieved by means of an amplitude modulation of the phase grating. For example, in [8] a blazed grating is used as a phase grating.

The illumination pattern in the sample plane is preferably an illumination pattern consisting of a plurality of illumination points, which may be arranged in a substantially planar arrangement or else in a two-dimensional, i.e. curve-like arrangement.

The term back-and-forth movement is intended to mean any wobbling or thrashing about, not defined in any more detail, by means of which the irradiation of the sample is areally homogenized in such a way that the unwanted spot-like light structures disappear in the relevant regions. In general, this is not intended to mean that the illumination pattern or the illumination points are moved back and forth only in one direction or along one direction. However, it is possible that the illumination pattern or the illumination points are moved back and forth only in one direction.

The term wobble device is intended to denote optical devices that can be used to bring about this back-and-forth movement of the illumination pattern or of illumination points. The controller may be advantageously configured to control the controllable wobble device.

Detection light is electromagnetic radiation emitted by the sample illuminated with the excitation light. Emitting means that the detection light comes from the sample. The detection light can be reflected back from the sample or can be light which is transmitted through the illuminated sample. The detection light can typically be, in comparison with the excitation light, red-shifted fluorescence from fluorescent markers used to prepare the sample.

Commercially available detectors can be used as detectors. Particularly preferably, semiconductor detectors are used. The detector can be in particular a two-dimensionally spatially resolving detector, thus a camera, for example a CCD, CMOS or SPAD array camera. However, for specific microscopy techniques, for example those in which an illumination point or an illumination line is scanned over or through the sample, it is possible to use a punctiform detector, for example a photomultiplier, or a linear detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy, for reflected-light microscopy and for light sheet microscopy, in which the sample is illuminated obliquely and observed orthogonally thereto.

An essential concept of the present invention can be considered that of a homogenization of the irradiation of a region to be illuminated being achieved by virtue of the region to be illuminated being irradiated using an illumination pattern that per se does not yet implement the homogeneous irradiation but that is moved back and forth with the aid of a simple optical device, the wobble device, such that the illumination pattern is smeared or washed out over a certain region.

A first advantage of the invention can be considered to be the fact that very homogeneous irradiations of a desired region to be illuminated are possible by way of a measure exhibiting little complexity in terms of apparatus and method. Desired regions to be illuminated are usually also referred to as ROIs (ROI=region of interest). The invention can be used in many different ways, especially in multimodal microscopes.

In principle, the wobble device being configured for moving the illumination pattern back and forth in one dimension is sufficient for realizing the invention. To this end, provision can be made for at least a part of the wobble device, for example a plane parallel transparent plate or a scanner mirror, to be pivotable about at least one pivot axis.

In an advantageous exemplary embodiment, the wobble device is configured for moving the illumination pattern back and forth in two dimensions. For example, this may be realized by virtue of a first part of the wobble device, for example a first plane parallel transparent plate or a first scanner mirror, being pivotable about a first pivot axis and a second part of the wobble device, for example a second plane parallel transparent plate or a second scanner mirror, being pivotable about a second pivot axis that extends at right angles to the first pivot axis. However, it is also possible that at least one part of the wobble device, for example a plane parallel transparent plate or a scanner mirror, is pivotable about two mutually independent pivot axes. Finally, it is also possible in principle that the wobble device is configured for moving the illumination pattern back and forth in three dimensions.

Advantageously, the controllable wobble device may be operable in resonant and/or quasi-static fashion. For example, the controllable wobble device may be galvanometrically driveable and/or driveable by means of a MEMS device, and the galvanometric drive and/or a MEMS drive may be present.

In a particularly preferred exemplary embodiment, the controllable wobble device comprises at least one pivotable plate that is transparent to the manipulation light, arranged in an intermediate image plane or in the vicinity of an intermediate image plane and traversed by the illumination beam path. The transparent plate may be pivotable about two pivot axes that are perpendicular to one another and to an optical axis. However, it is also possible that a first transparent plate and a second transparent plate are present, the first transparent plate is pivotable about a first pivot axis, which is perpendicular to an optical axis, and the second transparent plate is pivotable about a second pivot axis, which is perpendicular to the optical axis and to the first pivot axis. The transparent plate, the first transparent plate and/or the second transparent plate may advantageously be plane parallel plates.

In a second particularly preferred exemplary embodiment, the controllable wobble device comprises at least one scanner mirror which is arranged in a pupil plane or in the vicinity of a pupil plane of the illumination beam path and off which the illumination beam path is reflected. The scanner mirror may be pivotable about two pivot axes that are perpendicular to one another and to an optical axis. However, it is also possible that a first scanner mirror and a second scanner mirror are present, the first scanner mirror is pivotable about a first pivot axis, which is perpendicular to an optical axis, and the second scanner mirror is pivotable about a second pivot axis, which is perpendicular to the optical axis and to the first pivot axis.

In principle, it is also possible to use a wobble device in which a transparent plate that is pivotable about one axis is used for a variation of the illumination pattern in a first coordinate direction and in which a scanner mirror that is pivotable about one axis is used for the variation of the illumination pattern in a second coordinate direction that is perpendicular to the first coordinate direction.

In principle, it would be possible for the scanner mirrors to be arranged in the back focal plane of the microscope objective or in the vicinity of said plane. For practical reasons, this is generally discarded for reasons of restricted installation space and frequently already due to the fact that the back focal plane is situated within the microscope objective. A relay optics unit, in particular a 4f optics unit, may be present for providing a further intermediate image plane and a further pupil plane.

A further spatial light modulator may be arranged in the additional intermediate image plane or in the vicinity of this plane, and said further spatial light modulator may for example be used for structured illumination microscopy (SIM=structured illumination microscopy) and for TIRF microscopy (TIRF=total-internal reflection fluorescence microscopy) or combinations of these methods. However, it would also be possible, in particular for the aforementioned purposes, to arrange a further spatial light modulator in the illumination beam path in an intermediate image plane upstream of the tube lens.

In preferred configurations of the apparatus according to the invention and of the method according to the invention, the sample is irradiated with the complete illumination pattern. This would be the case should the optical manipulator according to the invention and the microscope according to the invention be used as a wide-field microscope, in which for example a rectangular region of chosen dimensions on the sample is irradiated with the manipulation light, which is excitation light for the fluorescent dyes in the sample in this case. However, it is also possible that the illumination pattern is composed of a plurality of partial patterns and that the control device is configured to control the spatial light modulator for temporally sequential display of the partial patterns.

In a simple variant, the illumination pattern or a partial pattern comprises at least one illumination point in the image plane. The illumination pattern or a partial pattern may also be implemented by a single point. In the case of a partial pattern formed by a single point, the control device may advantageously be configured to control the wobble device in such a way that a partial pattern formed by a single illumination point is moved back and forth in one or two dimensions with an amplitude of the order of a shortest distance of the illumination point from a further illumination point of the illumination pattern, in such a way that points in the surroundings of the illumination point are irradiated uniformly with manipulation light.

However, it is also possible that the illumination pattern or a partial pattern comprises a plurality of illumination points that are arranged along a linear path length. In particular, the path length might not be curved. The illumination pattern may also be composed of a plurality of partial patterns that are each arranged along a linear path length. In preferred embodiment variants, the illumination points of the illumination pattern or of individual partial patterns may in each case form a one-dimensional grid along the linear path length, and the control device may be configured to control the wobble device in such a way that the illumination points of the respective one-dimensional grid are moved back and forth along the extent of the relevant one-dimensional grid with an amplitude of the order of the grid constant of said one-dimensional grid, in such a way that the points along the linear path length are each irradiated uniformly with manipulation light.

Should one of the partial patterns of a curvy illumination pattern consist of only a single illumination point, this single illumination point may advantageously be moved back and forth in one dimension, and a movement direction of the illumination point may advantageously be chosen such that a profile of the curvy illumination pattern that is as smooth as possible is achieved.

In important exemplary embodiments of the method according to the invention and the apparatus according to the invention, the illumination pattern or a partial pattern comprises a two-dimensional arrangement of illumination points or is formed by such a two-dimensional arrangement. The two-dimensional arrangement of illumination points may preferably realize a two-dimensional grid, and the control device may be configured to control the wobble device in such a way that the illumination points of the two-dimensional grid are moved back and forth in two dimensions with amplitudes of the order of grid constants of the two-dimensional grid, in such a way that points in a two-dimensional region are each irradiated uniformly with manipulation light. In this case, grid constants refer to the grid constants in the two mutually independent directions of extent of the grid.

In a specific exemplary embodiment, the control device may for example be configured to control the wobble device in such a way that individual points of an irradiated region each run through Lissajous figures in the image plane. In particular, consideration is given to those Lissajous figures in which a surface region to be irradiated is impinged as uniformly as possible with radiation in the shortest possible time. In cases in which the wobble device is formed by a transparent plate that is pivotable about two axes or a scanner mirror that is pivotable about two axes, a vibration frequency at which the transparent plate or the scanner mirror is pivoted about the first axis is preferably not equal to a vibration frequency at which the transparent plate or the scanner mirror is pivoted about the second axis. Accordingly, in cases in which the wobble device is formed by two transparent plates each pivotable about one axis or by two scanner mirrors each pivotable about one axis, a vibration frequency at which the first plate or the first scanner mirror is pivoted is not equal to a vibration frequency at which the second plate or the second scanner mirror is pivoted. For example, it may be advantageous if the vibration frequency of the pivoting about the first axis differs only to a small extent from the vibration frequency of the pivoting about the second axis, for example by less than 20%, preferably by less than 10% and particularly preferably by less than 5%.

An essential advantage of these variants is that the wobble device may vibrate resonantly in one coordinate direction. Should the resonant frequencies in a first coordinate direction and in a second coordinate direction advantageously differ in view of quickly achieving a homogeneous irradiation of a surface, the wobble device may also be operated in resonantly vibrating fashion in both coordinate directions.

In an advantageous configuration of the microscope according to the invention, the control unit of the optical manipulator is configured to control the wobble device during dead times of the detector. Thus, the sample may be optically manipulated during dead times of the detector in particular. For example, the optical manipulator and in particular the control unit may be configured to perform bleaching of fluorescent dyes, quenching of fluorescent dyes and/or releasing of particles in the sample during dead times of the detector.

However, it is also possible that the control unit is configured to actuate the wobble device during exposure times of the detector. Thus, the sample may be illuminated by the manipulation light as excitation light and/or by further excitation light during exposure times of the detector. For example, the excitation light for the microscope is realized by the manipulation light of the optical manipulator when the optical manipulator is used for a wide-field illumination of the sample with manipulation light that is suitable for exciting fluorescent dyes, with which a sample to be examined has been prepared, to fluoresce.

However, it is also possible that at least one further illumination unit is present for the provision of excitation light. For example, a laser scanning illumination may be provided by a further illumination unit. Illumination light of the further illumination unit may advantageously be input coupled into a collimated region of the beam path, for example into a collimated region of the illumination beam path, in particular between a back focal plane of the microscope objective and a tube lens.

At least one further detection unit for the provision of a further detection channel with at least one further detector may also be present for further microscopic methods. For example, at least one of the detectors may be a confocal detector for an LSM method (LSM=laser scanning microscopy) and may be situated in a descanned part of the beam path in particular. Detection light to be guided into a further detection unit may be output coupled into the further detection unit in a collimated region of the beam path, for example in a collimated region of the detection beam path, in particular between a back focal plane of the microscope objective and a tube lens.

Further advantages and features of the present invention are described below in connection with the appended figures, in which:

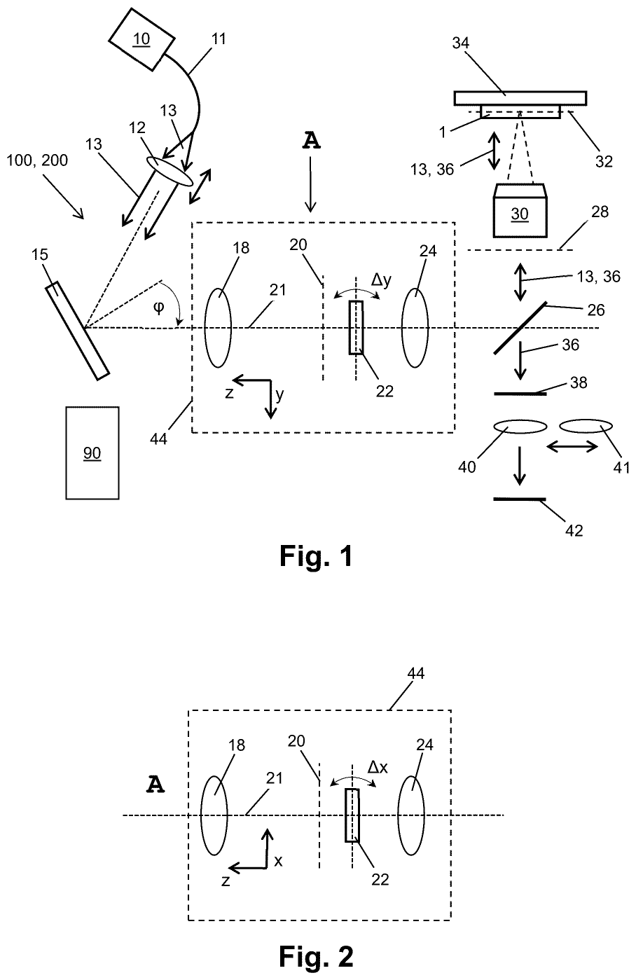

FIG. 1: shows a schematically illustrated exemplary embodiment of a device according to the invention and a microscope according to the invention;

FIG. 2: shows a detail of the microscope from FIG. 1 in the viewing direction of arrow A in FIG. 1;

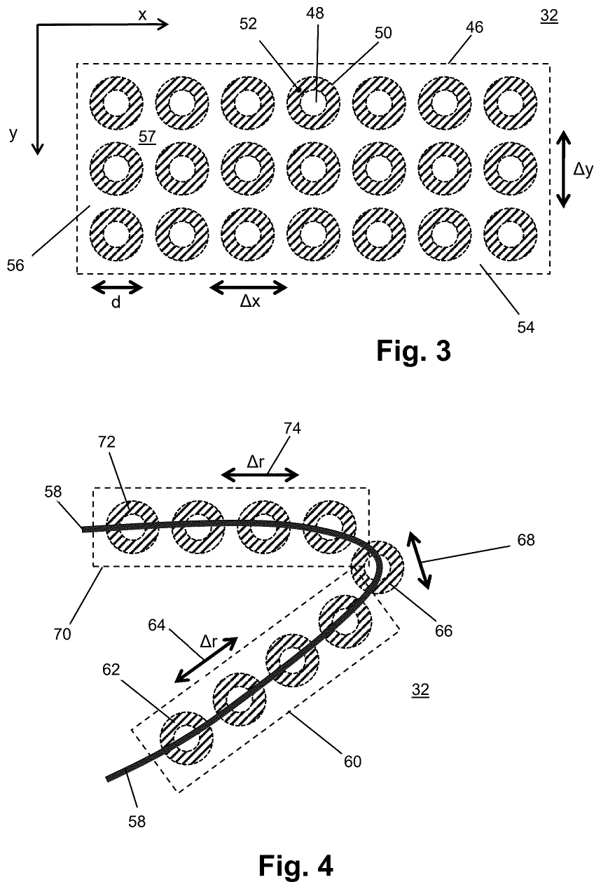

FIG. 3: shows an example of a region to be manipulated or illuminated in a sample plane;

FIG. 4: shows an example of a trajectory to be manipulated or illuminated in a sample plane; and

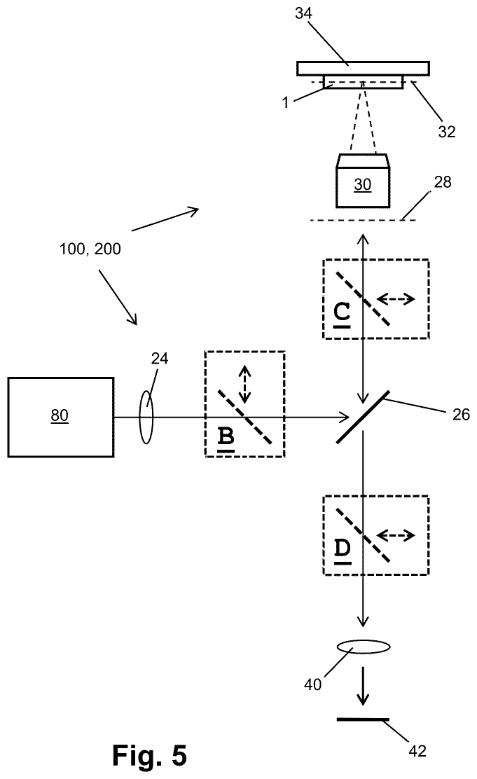

FIG. 5: shows examples for additions to the apparatus or microscope from FIG. 1.

Identical and identically acting components are generally provided with the same reference signs in the figures.

An exemplary embodiment of an apparatus 100 according to the invention for microscopic optical manipulation of a sample 1 and an exemplary embodiment of a microscope 200 according to the invention are explained with reference to FIGS. 1 to 3.

According to the invention, the apparatus 100 for microscopic optical manipulation of the sample, shown schematically in FIG. 1, initially comprises a light source 10 for transmitting manipulation light 13 and an illumination beam path with a microscope objective 30 for guiding the manipulation light 13 onto or into a sample 1 to be manipulated located in a sample plane 32. In the illumination beam path, a spatial light modulator 15 is arranged in or in the vicinity of a pupil plane of the illumination beam path. Furthermore, a controller 90, for example a PC, is present at least for controlling the spatial light modulator 15, said controller being configured to control the spatial light modulator 15 for the purpose of implementing illumination patterns in the sample plane 32. According to the invention, a controllable wobble device 22 is thereupon present for moving an illumination pattern 57 (see FIG. 3) back and forth within the sample plane 32, and according to the invention the control device 90 is configured to control the wobble device 22 in such a way that amounts of light in each case radiated onto individual points in an irradiated region 46 (see FIG. 3) in the sample plane 32 are homogenized over a time interval.

The microscope 200 according to the invention shown in FIG. 1 initially comprises the apparatus 100 according to the invention, i.e. an optical manipulator according to the invention, as a constituent part. Furthermore, according to the invention, a detector 42 is present for detecting detection light 36 emitted by the sample 1 as a consequence of being illuminated with illumination light, and also a detection beam path which comprises the microscope objective 30 in the exemplary embodiment shown and serves to guide the detection light 36 to the detector 42. In the exemplary embodiment shown, the excitation light is implemented by the manipulation light 13, by means of which dye molecules, with which the sample 1 was prepared, are excited to fluoresce. In particular, the detection light 36 may be fluorescence coming from the sample 1.

In the exemplary embodiment shown in FIG. 1, the illumination beam path moreover comprises further constituent parts: optical fibre 11, collimation lens 12, lens 18, tube lens 24, main beam splitter 26. In the exemplary embodiment shown, the light source 10 may be a laser, and, in the exemplary embodiment shown, the spatial light modulator 15 may be a phase modulator, for example a liquid crystal on silicon light modulator (LCOS light modulator). The collimation lens 12, the lens 18 and the tube lens 24 may be implemented by glass lenses.

According to the invention, the phase modulator 15 is situated in a pupil plane of the illumination beam path. The pupil plane is created by the lens 18 which, together with the tube lens 24, images a back local plane 28 of the microscope objective 30 into the plane in which the phase modulator 15 is arranged.

In the exemplary embodiment depicted in FIGS. 1 and 2, the wobble device is realized by a plane parallel transparent plate 22 that is pivotable about two axes. In the exemplary embodiment shown in FIGS. 1 and 2, the plate 22 is arranged in the vicinity of an intermediate image plane 20. Together with the microscope objective 30, the tube lens 24 images the sample plane 32 into the intermediate image plane 20.

The main beam splitter 26 may be a dichroic beam splitter that reflects manipulation light 13 coming from the light source 10 in the direction of the microscope objective 30 and that transmits fluorescence 36 coming from the sample in the direction of the detector 42.

Furthermore, according to the invention, a detector 42 is present for detecting detection light 36 emitted by the sample 1 as a consequence of being illuminated with illumination light, and also a detection beam path which comprises the microscope objective 30 in the exemplary embodiment shown and serves to guide the detection light 36 to the detector 42.

In the exemplary embodiment shown, the detection beam path additionally comprises an emission filter 38 and a tube lens 40. By preference, the detector 42 may be arranged in an intermediate image plane of the detection beam path and may be realized by a detector with two-dimensional spatial resolution, for example a CMOS, CCD or SPAD camera. Instead of the tube lens 40, a further tube lens 41 is present, by means of which a different field size can be realized on the detector 42 and which can be inserted into the detection beam path by means of a tube lens interchanger.

Via the optical fibre 11, manipulation light 13 supplied by the laser 10 initially reaches the collimation lens 12 which radiates the manipulation light 13, in a collimated beam, onto the phase modulator 15, which transmits the manipulation light in the direction of the lens 18. The angle φ of the phase modulator 15 relative to the optical axis 21 may be adjustable. Thereupon, the manipulation light passes through the intermediate image plane 20 and is incident on the plate 22, passes through the latter and, via the tube lens 24 and the main beam splitter 26 and via the back focal plane 28 of the microscope objective 30, reaches into the microscope objective 30 and is guided, for example focused, by the latter into the sample plane 32 and into the sample 1. The sample 1 is arranged on a schematically shown sample holder 34.

FIG. 2 shows, from a viewing direction denoted by A, the components subsumed within the dashed box 44 in FIG. 1. As illustrated in FIG. 1, the plate 22 may be pivoted about the x-axis. Within the sample plane 32, this brings about a displacement of light points in the y-direction. Independently thereof and as illustrated in FIG. 2, the plate 22 may be pivoted about the y-axis which, within the sample plane 32, brings about a displacement of light points in the x-direction (see FIG. 3). The coordinate directions of a right-hand orthogonal coordinate system are in each case specified in the figures. The z-direction corresponds to the direction of the optical axis between the phase modulator 15 and the main beam splitter 26. A resonantly and a quasi-statically operable galvanometric drive, not shown in the figures, may be present for pivoting the plate 22 about two axes.

For example via connection lines not depicted separately in the figures, the controller 90 is suitably operationally connected to components for the control and/or data evaluation of which said controller is configured.

The basic principle of the invention is now explained on the basis of the example in FIG. 3. There, a rectangular region 46 should be illuminated as uniformly as possible.

To this end, the sample is illuminated using an illumination pattern 56 that is formed by a plurality of substantially identical illumination points 50. One of the illumination points 50 has been provided with a reference sign by way of example in FIG. 3. The control of the phase modulator 15 required for this illumination pattern may be obtained using one of the methods mentioned in the general part of the description. The illumination points 50 are arranged in the style of a two-dimensional rectangular grid 57. At its centre, each of the illumination points 50 has a central region 48 of maximum intensity, which is surrounded by an edge region 52 with a diameter d. In the edge region 52, the light intensity drops down to zero towards the outside. Thus, the light intensity is in each case zero between the individual illumination points 50.

The more densely the illumination points 50 are set, the smaller the necessary displacements of the illumination pattern 57 that for the purpose of filling the gaps between the illumination points 50 should be brought about by means of the wobble device present according to the invention.

According to the invention, the illumination pattern 57 in the example of FIG. 3 is now moved back and forth in the image plane 32 by actuating the plate 22. The amplitude Δx with which the illumination pattern 57 is moved back and forth in the x-direction may for example be chosen to be as large as the grid constant of the grid 57 in the x-direction. The amplitude Δy with which the illumination pattern 57 is moved back and forth in the y-direction may for example be chosen to be as large as the grid constant of the grid 57 in the y-direction. As a result, the illumination pattern 57 is smeared or washed out over the region 46 and the amounts of light respectively radiated at the points within the region 46 are homogenized. In general, the homogenization attainable with the method according to the invention and the optical manipulator according to the invention is very good. Scanning of the illumination pattern 57, for example in the form of Lissajous figures, may for example be performed during integration times or exposure times of the detector 42. To this end, the plate 22 could vibrate resonantly. Only in the edge regions 56 is the attainable homogenization not as good. There, the amount of light introduced per point during an integration time of the detector 42 reduces continuously to zero over a finite path length. As a rule, this does not play too much of a role in the case of relatively large illumination areas.

It is also possible to illuminate the region 46 during dead times of the detector 42, for example in order to release certain molecules in this region (uncaging) or to quench fluorescence molecules in this region.

Instead of continual displacements of the illumination pattern 57, the latter could in each case also be displaced by a certain number of discrete steps in both the x-direction and the y-direction, for example by three steps per grating constant, like in microscopy with structured illumination.

Should the illumination accuracy be considered to be insufficient, for example in the edge region 56 of the region 46 to be illuminated, it may prove helpful to optionally decompose a two-dimensional pattern into linear partial patterns that are radiated temporally sequentially one after the other into the sample plane 32.

One example to this end is explained in the context of FIG. 4. A curved lens 58 that should be illuminated is shown there. To this end, an illumination pattern is initially formed; it consists of a total of nine illumination points in the style of the illumination points 50 from FIG. 3.

Just like in the example explained in the context of FIG. 3, it would now also be possible to displace the entire illumination pattern back and forth in the two coordinate directions. However, this would increase the edge regions in which it is not possible to obtain a good homogenization of the amounts of light. For this purpose, a first partial pattern 60, a second partial pattern 66 and a third partial pattern 70 are formed. The first partial pattern 60 consists of four similar illumination points 62, which are linearly arranged in grid-like fashion. The second partial pattern 66 is formed by a single illumination point. The third partial pattern 70 once again consists of four similar illumination points 72, which are linearly arranged in grid-like fashion. To implement the line-like illumination along the curved line 48, the first partial pattern 60 is initially radiated into the sample plane 32 and moved back and forth in the direction indicated by the arrow 64, i.e. in the direction of extent of the first partial pattern 60, using the wobble device 22. This may be implemented at an amplitude Δr that approximately corresponds to the spacing of the illumination points 62 in the first partial pattern 60. Then, the illumination point 66, which forms the second partial pattern, may be moved back and forth in the direction indicated by the arrow 68, for example with the same amplitude Δr, as the illumination points 62 of the first partial pattern 60. The direction in which the single illumination point 66 is moved back and forth in the sample plane 32 is advantageously chosen in such a way here that, overall, a profile of the illuminated region that is as smooth as possible is achieved. Finally, the illumination points 72 of the third partial pattern 70 are moved back and forth in the direction indicated by the arrow 74, once again with an amplitude of Ar, which approximately corresponds to the spacing of the illumination points 72 of the third partial pattern 70. This entire procedure may be implemented during a dead time of the detector 42, for instance when the sample regions along the curved line 58 should be bleached. However, the described temporally sequential irradiation may also be performed during an integration time, i.e. an exposure time of the detector 42, for example if the region along the curved line 58 is an ROI that should be examined using fluorescence microscopy.

FIG. 5 illustrates options for providing further illumination units or further detection units for the structure shown in FIG. 1. To this end, only a few essential components of the structure from FIG. 1 are shown in FIG. 5. For example, reference sign B may be a laser scanning illumination and detection unit, by means of which excitation light is input coupled into the collimated part of the illumination beam path between the tube lens 24 and the back focal plane 28 of the microscope objective 30 and fluorescence from the sample is output coupled. A detector of the unit B may be arranged in a descanned part of the beam path of the unit B and may be a confocal detector or else a detector that can be used to measure a detection point distribution function with spatial resolution. The unit C may be an illumination unit that for example supplies excitation light for structured illumination microscopy or for TIRF microscopy or combinations thereof. Coupling is once again implemented in what is known as the infinity space, i.e. in the portion of the illumination beam path between the tube lens 24 and the back focal plane 28 of the microscope objective 30.

For example, the unit D may be a detection unit with a further detector. Detection light is once again output coupled in the infinity space, in this case in the part of the illumination beam path between the tube lens 40 of the detection beam path and the back focal plane 28 of the microscope objective 30.

The present invention provides an optical manipulator, a method for microscopic optical manipulation of a sample, a microscope and a microscopy method, in which illumination patterns can be generated particularly precisely.

### LIST OF REFERENCE SIGNS

1 Sample
10 Light source, laser
11 Optical fibre
12 Lens
13 Manipulation light, excitation light
15 Spatial light modulator, phase modulator, with adjustable angle φ relative to the optical axis 21
18 Lens
20 Intermediate image plane
21 Optical axis
22 Wobble device, transparent plane parallel plate, glass plate
24 Tube lens
26 Main beam splitter
28 Back focal plane of microscope objective 30, pupil plane
30 Microscope objective
32 Focal plane of microscope objective 30, sample plane
34 Sample holder
36 Light reflected back from sample 1 as a result of irradiation with excitation light
38 Emission filter
40 Tube lens in the detection beam path
41 Alternative tube lens in the detection beam path
42 Detector, camera
44 Group of components of the apparatus 100 according to the invention
46 Region in sample plane 32 to be illuminated
48 Central region, centre of luminous spot 50
50 Luminous spot, luminous point, illumination point
52 Edge of the luminous spot 48
56 Edge region of the region 46
57 Illumination pattern, two-dimensional grid
58 Trajectory to be illuminated in sample plane 32
60 First group of illumination points 62, first partial pattern, one-dimensional grid
62 Illumination point
64 Movement interval and movement direction of the illumination points 72 of the first group 60
66 Illumination point, second partial pattern
68 Movement interval and movement direction of illumination point 66
70 Second group of illumination points 72, third partial pattern, one-dimensional grid
72 Illumination point
74 Movement interval and movement direction of the illumination points 72 of the group 70
80 Parts of the illumination beam path of the apparatus 100 according to the invention
90 Control unit, PC
100 Apparatus according to the invention
200 Microscope according to the invention
A Viewing direction of the illustration in FIG. 2
B Input coupling of excitation light and/or output coupling of detection light
C Input coupling of excitation light and/or output coupling of detection light
D Input coupling of excitation light and/or output coupling of detection light
d Diameter of a luminous spot 50
Δr Grid constant, approx. amplitude of the wobbling back and forth
Δx Grid constant, approx. amplitude of the wobbling back and forth in the x-direction
Δy Grid constant, approx. amplitude of the wobbling back and forth in the y-direction
φ Angle of normal direction of the surface of the spatial light manipulator 15 relative to the optical axis 21, adjustable

### REFERENCES

[1] Pozzi P. et al.: High-throughput spatial light modulation two-photon microscopy for fast functional imaging; In Neurophotonics vol. 2, page 015005-1 (2015)
[2] Fiolka R., Beck M., and Stemmer A.: Structured illumination in total internal reflection fluorescence microscopy using a spatial light modulator; In Optics Letters vol. 33, page 1629 (2008)
[3] Shao L.; Kner P.; Hesper E.; Gustafsson Mats G. L: Super-resolution 3D-microscopy of live whole cells using structured illumination; In Nature Methods, vol. 8 (2011)
[4] Golan L.; and Shoham S.: Speckle elimination using shift-averaging in high-rate holographic projection; In Optics Express vol. 17, page 1330 (2009)
[5] Chang Ch. et al.: Speckle-suppressed phase-only holographic three-dimensional display based on double-constraint Gerchberg-Saxton algorithm; In Applied Optics vol. 54, page 6994 (2015)
[6] Mau, A., Friedl, K., Leterrier, C. et al.: Fast widefield scan provides tunable and uniform illumination optimizing super-resolution microscopy on large fields. In Nat Commun 12, 3077 (2021). https://doi.org/10.1038/s41467-021-23405-4
[7] Lucas Herdly, Paul Janin, Ralf Bauer, and Sebastian van de Linde: Tunable Wide-Field Illumination and Single-Molecule Photoswitching with a Single MEMS Mirror; In: ACS Photonics 2021 8 (9), 2728-2736; DOI: 10.1021/acsphotonics.1c00843
[8] Davis J. et al.: Encoding amplitude information onto phase-only filters, In Appl. Opt. 38, page 5004 (1999)
[9] R. Gerchberg et al.: A Practical Algorithm for the Determination of Phase from Image and Diffraction Plane Pictures, In Optik vol. 35, page 237 (1972)
[10] Reicherter M. et al.:
   Optical particle trapping with computer-generated holograms written on a liquid-crystal display, In Opt. Lett. 24, page 608 (1999)
[11] Poland S. et al.: Development of a doubly weighted Gerchberg-Saxton algorithm for use in multibeam imaging applications, In Opt. Lett. 39, page 2431 (2014)

1. Apparatus for microscopic optical manipulation of a sample, the apparatus comprising:
a light source for transmitting manipulation light,
an illumination beam path with a microscope objective for guiding the manipulation light onto and/or into a sample to be manipulated located in a sample plane,
wherein a spatial light modulator is arranged in the illumination beam path, in or near a pupil plane of the illumination beam path, and
a controller at least for controlling the spatial light modulator, said controller being configured to control the spatial light modulator for implementing illumination patterns in the sample plane,
wherein the illumination beam path comprises a controllable wobble device for moving an illumination pattern back and forth within the sample plane and
wherein the control device is configured to control the wobble device in such a way that amounts of light in each case radiated onto individual points in an irradiated region in the sample plane are homogenized over a time interval.

2. Apparatus according to claim 1,
wherein the wobble device is configured for moving the illumination pattern back and forth in two dimensions.

3. Apparatus according to claim 1,
wherein the wobble device is operable in resonant and/or quasi-static fashion.

4. Apparatus according to claim 1,
wherein the wobble device comprises at least one of: at least one pivotable plate that is transparent to the manipulation light, arranged in an intermediate image plane or in the vicinity of an intermediate image plane and traversed by the illumination beam path or at least one scanner mirror which is arranged in a pupil plane or in the vicinity of a pupil plane of the illumination beam path and off which the illumination beam path is reflected.

5. (canceled)

6. Apparatus according to claim 1,
further comprising a relay optics unit for providing a further intermediate image plane and a further pupil plane.

7. Apparatus according to claim 1,
wherein the illumination pattern is composed of a plurality of partial patterns and
wherein the control device is configured to control the spatial light modulator for temporally sequential display of the partial patterns.

8. Apparatus according to claim 1,
wherein the illumination pattern or a partial pattern comprises at least one illumination point in the image plane.

9. Apparatus according to claim 8,
wherein the control device is configured to control the wobble device in such a way that a partial pattern formed by a single illumination point is moved back and forth in one or two dimensions with an amplitude of the order of a shortest distance of the illumination point from a further illumination point of the illumination pattern, in such a way that points in the surroundings of the illumination point are irradiated uniformly with manipulation light.

10. Apparatus according to claim 1,
wherein the illumination pattern or a partial pattern comprises a plurality of illumination points that are arranged along a linear path length.

11. Apparatus according to claim 10,
wherein the illumination pattern is composed of a plurality of partial patterns that are each arranged along a linear path length.

12. Apparatus according to claim 10,
wherein the illumination points of the illumination pattern or of individual partial patterns in each case form a one-dimensional grid along the linear path length and
wherein the control device is configured to control the wobble device in such a way that the illumination points of the respective one-dimensional grid are moved back and forth along the extent of the relevant one-dimensional grid with an amplitude of the order of the grid constant of said one-dimensional grid, in such a way that the points along the linear path length are each irradiated uniformly with manipulation light.

13. Apparatus according to claim 1,
wherein the illumination pattern or a partial pattern comprises a two-dimensional arrangement of illumination points.

14. Apparatus according to claim 13,
wherein the two-dimensional arrangement of illumination points realizes a two-dimensional grid and
wherein the control device is configured to control the wobble device in such a way that the illumination points of the two-dimensional grid are moved back and forth in two dimensions with amplitudes of the order of grid constants of the two-dimensional grid, in such a way that points in a two-dimensional region are each irradiated uniformly with manipulation light.

15. Apparatus according to claim 1,
wherein the control device is configured to control the wobble device in such a way that individual points of an irradiated region each run through Lissajous figures in the image plane.

16. Microscope comprising:
an apparatus according to claim 1,
a detector for detecting detection light emitted by the sample owing to illumination with excitation light, and
a detection beam path, comprising the microscope objective or a further microscope objective, for guiding the detection light onto the detector.

17. Microscope according to claim 16,
wherein the apparatus for optical manipulation is configured to perform bleaching of fluorescent dyes, quenching of fluorescent dyes and/or releasing of particles in the sample during dead times of the detector.

18. Microscope according to claim 16,
wherein the excitation light is the manipulation light.

19. Microscope according to claim 16,
further comprising at least one further illumination unit for the provision of excitation light.

20. Microscope according to claim 16,
further comprising at least one further detection unit for the provision of a further detection channel with at least one further detector.

21. Method for microscopic optical manipulation of a sample,
the method comprising:
guiding manipulation light onto and/or into a sample to be examined located in a sample plane, via an illumination beam path with a microscope objective,
guiding the manipulation light via a spatial light modulator that is arranged in or near a pupil plane of the illumination beam path, and
modulating the manipulation light by the spatial light modulator for realizing an illumination pattern in the sample plane,
wherein at least parts of the illumination pattern are moved back and forth in the image plane
in at least one dimension by a wobble device, for homogenizing amounts of light in each case radiated onto individual points of an irradiated region in the sample plane over a time interval.

22. Microscopy method, comprising:
manipulating a sample using the method according to claim 21,
illuminating the sample by the manipulation light as excitation light and/or by further excitation light and
guiding detection light emitted by the sample owing to illumination with excitation light onto a detector via the microscope objective or a further microscope objective and
detecting the detection light by said detector.

23. Method according to claim 22,
wherein the sample is optically manipulated during dead times of the detector.

24. Method according to claim 22,
wherein the sample is illuminated by the manipulation light as excitation light and/or by further excitation light during exposure times of the detector.
